(19) United States
(12) Patent Application Publication
(10) Pub. No.: US 2021/0398081 A1
(43) Pub. Date: Dec. 23, 2021

(54) COMPUTER ARCHITECTURE FOR SOFTWARE TO IMPROVE COMPUTER RESOURCE UTILIZATION BASED ON SECURE WORKSPACE DATA RETRIEVED OVER A NETWORK

(71) Applicant: Paylocity Corporation, Schaumburg, IL (US)

(72) Inventors: Edward William GATY, Northbrook, IL (US); Adam McELHINNEY, Chicago, IL (US)

(21) Appl. No.: 16/904,433

(22) Filed: Jun. 17, 2020

(51) Int. Cl. G06Q 10/10; G06Q 30/02; G06Q 40/00; G06F 11/34

(52) U.S. Cl. CPC G06Q 10/105; G06F 11/3428; G06Q 40/125; G06Q 30/0201

(57) ABSTRACT

Methods are provided for improving computer resource utilization based on computer-implemented analysis of secure workspace data retrieved over a network connection. In one aspect, a plurality of encrypted workspace data is retrieved from a plurality of secure workspace data repositories associated with a plurality of human resources service workspaces. The plurality of encrypted workspace data is decrypted to produce a plurality of decrypted workspace data. A plurality of customer engagement metrics are calculated based on the plurality of decrypted workspace data, wherein each of the customer engagement metrics is associated with at least one of the plurality of human resources service workspaces. A composite customer engagement score is calculated based on the plurality of customer engagement metrics. Systems and machine-readable media are also provided.

### TECHNICAL FIELD

The present disclosure generally relates to a computer architecture for software to improve computer resource utilization, and more specifically relates to improving computer resource utilization based on secure workspace data retrieved over a network.

### BACKGROUND

Human resources service providers support customers with services in a variety of computer-based workspaces focused on categories of human resources services such as compensation, onboarding, time and labor scheduling, performance, benefits, payroll, community, expense reimbursement, learning, and employee surveys. Providers increasingly rely on a broad range of technical resources to support their customers. For example, providers may offer dedicated computer-based interfaces to enable convenient, efficient, and secure interaction with customers and customer employees. In addition, many of these services involve recording, processing, and preserving large volumes of customer and employee data that must be transmitted and stored securely to protect customer confidentiality and employee privacy. Providers may use dedicated computers and networks to handle such data and provide services across a variety of different service workspaces.

Effective utilization of computer resources supporting such human resources services can provide significant value for both customers and their employees. For example, higher levels of computer resource utilization and computer-based engagement with a human resources provider can result in even further increases in efficiency and performance for customers and their employees. However, tracking and measuring such customer engagement and computer resource utilization across a wide range of human resources service workspaces is challenging. Computer-based systems with appropriate data algorithms to analyze large volumes of secure data to measure and improve customer engagement and computer resource utilization are commonly not available to human resources service and technology providers.

The description provided in the background section should not be assumed to be prior art merely because it is mentioned in or associated with the background section. The background section may include information that describes one or more aspects of the subject technology.

### SUMMARY

The disclosed computer-implemented methods and systems provide for improved computer resource utilization through the decryption and analysis of secure human resources data across a variety of service workspaces. This data is used to calculate a customer engagement score that may be used to track and improve customer engagement and computer resource utilization.

According to certain aspects of the present disclosure, a computer-implemented method is provided for improving computer resource utilization is provided. A plurality of encrypted workspace data is received from a plurality of secure workspace data repositories associated with a plurality of human resources service workspaces. The plurality of encrypted workspace data is decrypted to produce a plurality of decrypted workspace data. A plurality of customer engagement metrics are calculated based on the plurality of decrypted workspace data, wherein each of the customer engagement metrics is associated with at least one of the plurality of human resources service workspaces. A composite customer engagement score is calculated based on the plurality of customer engagement metrics.

According to other aspects of the present disclosure, a system for improving computer resource utilization is provided. The system includes a networked storage device configured to store a plurality of secure workspace data repositories associated with a plurality of human resources service workspaces, wherein the plurality of secure workspace data repositories contain a plurality of encrypted workspace data. The system further includes at least one processor configured to execute computer code, which, when executed, causes the processor to retrieve the plurality of encrypted workspace data from each of a plurality of secure workspace data repositories, to decrypt the plurality of encrypted workspace data to produce a plurality of decrypted workspace data, to calculate a plurality of customer engagement metrics based on the plurality of decrypted workspace data, wherein each of the customer engagement metrics is associated with at least one of the plurality of human resources service workspaces, and to calculate a composite customer engagement score based on the plurality of customer engagement metrics.

According to other aspects of the present disclosure, a non-transitory machine-readable storage medium is provided. The storage medium comprises machine-readable instructions which, when executed by at least one data processor forming part of at least one computing system, results in operations that include retrieving a plurality of encrypted workspace data from a plurality of secure workspace data repositories associated with a plurality of human resources service workspaces, decrypting the plurality of encrypted workspace data to produce a plurality of decrypted workspace data, calculating a plurality of customer engagement metrics based on the plurality of decrypted workspace data, wherein each of the customer engagement metrics is associated with at least one of the plurality of human resources service workspaces, and calculating a composite customer engagement score based on the plurality of customer engagement metrics.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example architecture for improving computer resource utilization.

FIG. 2 is a block diagram illustrating the example computer resource utilization monitoring system from and service workspace servers of the architecture of FIG. 1 according to certain aspects of the disclosure.

FIG. 3 illustrates an example process for improving computer resource utilization for a human resources service and technology provider maintaining a plurality of service workspaces.

FIG. 4 is an example illustration associated with the example processes of FIG. 3.

FIG. 5 illustrates another example process for improving computer resource utilization for a human resources service and technology provider maintaining a plurality of service workspaces.

FIG. 6 illustrates another example process for improving computer resource utilization for a human resources service and technology provider maintaining a plurality of service workspaces.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

The disclosed system provides for improved computer resource utilization and customer engagement for human resources service and technology providers based on secure workspace data retrieved over a network. A human resources service and technology provider maintains a variety of workspaces to support a variety of different services, such as compensation, onboarding, time and labor scheduling, performance, benefits, payroll, community, expense reimbursement, learning, and employee surveys. To support these various workspaces, the human resources service and technology provider maintains a number of secure workspace data repositories that store encrypted workspace data associated with the various service workspaces. This secure data may be decrypted for analysis and improvement of computer resource utilization to improve customer engagement. A computer resource utilization monitoring system may receive the decrypted workspace data and calculate a customer engagement metric for each human resources workspace based on the decrypted data. Based on the customer engagement metrics, the computer resource utilization monitoring system may calculate a composite customer engagement score. Preferably, the customer engagement score may enable the human resources service and technology provider to assess engagement with each customer and to maximize computer resource utilization across the variety of service and technology workspaces.

The disclosed system provides an improvement to computer functionality by allowing computer performance of a function not previously performed by a computer. Specifically, the disclosed system provides for improved utilization of computer systems maintained by a human resources service and technology provider for the benefit of its customers and their employees. Extensive computer systems and supporting technology platforms are necessary to provide such human resources services, and ensuring efficient utilization of these systems across a variety of service workspaces maximizes performance of the computer systems, improves the efficiency of the services provided to customers via those computer systems, and ultimately improves the efficiency and effectiveness of the customer and its employees and business operations.

By their nature, human resources services and technology involve data and information related to a variety of topics that are sensitive and confidential to employers and their employees, all of whom may be users of the computer systems maintained by the human resources service and technology provider. Employer and employee permission may be controlled, for example, using privacy controls integrated into the disclosed system. If requested user information includes demographic information, then the demographic information may be aggregated on a group basis and not by individual user. Each user may be provided notice that such user information will be stored with such explicit consent. The stored user information preferably may be encrypted to protect both confidentiality and security of the employers and employees.

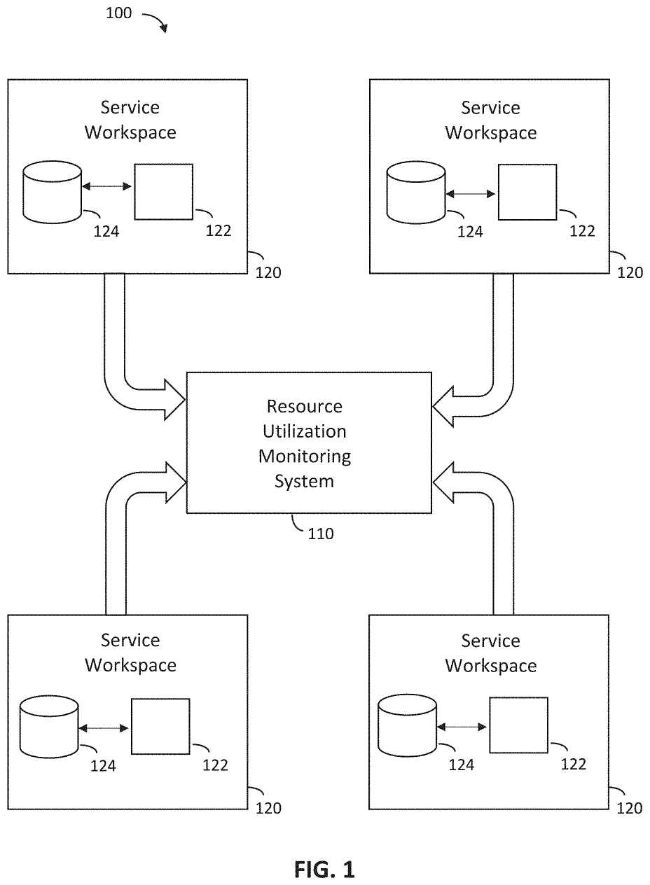

FIG. 1 illustrates an example architecture 100 for improving computer resource utilization by a human resources service and technology provider and its customers. The architecture 100 includes human resources service workspaces 120 dedicated to specific services provided by the human resources service and technology provider. A workspace 120 provides all of the technology necessary to support particular services provided by the human resources service and technology provider. For example, the provider may maintain a workspace 120 dedicated to each of the service categories it provides, such as compensation, onboarding, time and labor scheduling, performance, benefits, payroll, community, expense reimbursement, learning, and employee surveys. Preferably, a separate workspace 120 may be maintained for each category of service, but multiple categories of services may be combined and supported by a common workspace 120 if desired.

Each human resources service workspace 120 preferably is associated with one or more networked computer servers 122 designed to support the services provided within that workspace 120. Depending on the needs of a particular human resources service and technology provider, multiple workspaces 120 may optionally share a common server 122. The servers 122 can be any device having an appropriate processor, memory, and communications capability for hosting human resources services and data. Each of the servers 122 may communicate with other servers 122 within a workspace 120 as well as with the servers 122 of other workspaces 120. The human resources service and technology provider, as well as its customers and their employees, may interact with the servers 122 using client devices connected to the servers 122 over a network. For example, the client devices may be desktop computers, mobile computers, tablet computers, mobile devices or any other devices having appropriate processor, memory, and communications capabilities. In certain aspects, one or more of the servers 122 can be a cloud computing server of an infrastructure-as-a-service (IaaS) and be able to support a platform-as-a-service (PaaS) and software-as-a-service (SaaS) services.

The networks used to support communications among servers 122 and with the human resources service and technology provider and its customers and their employees within this architecture 100 may include, for example, any one or more of a personal area network (PAN), a local area network (LAN), a campus area network (CAN), a metropolitan area network (MAN), a wide area network (WAN), a broadband network (BBN), the Internet, and the like. Further, the network 150 can include, but is not limited to, any one or more of the following network topologies, including a bus network, a star network, a ring network, a mesh network, a star-bus network, tree or hierarchical network, and the like.

Each workspace 120 also preferably includes one or more secure workspace data repositories 124. Depending on the needs of a particular human resources service and technology provider, multiple workspaces 120 may optionally share a common secure workspace data repository 124. The secure workspace data repositories 124 preferably store current and historical data associated with the services provided by the human resources service and technology provider within that workspace 120.

For example, in the compensation workspace 120, the secure workspace data repository 124 may store data associated with periodic compensation and bonus plans and payment for employees of a particular customer. In the onboarding workspace 120, the secure workspace data repository 124 may store data associated with the process of new employees beginning work with a particular customer. In the time and labor scheduling workspace 120, the secure workspace data repository 124 may store data associated with scheduling of a customer's workforce and time recorded by the employees within that workforce. In the performance workspace 120, the secure workspace data repository 124 may store data associated with employee performance reviews. In the benefits workspace 124, the secure workspace data repository 124 may store data associated with benefits provided to employees of a particular customer, such as health insurance and other types of non-wage benefits. In the payroll workspace 120, the secure workspace data repository 124 may store data associated with periodic wages paid to employees of a particular customer, as well as tax withholding and other related information. In the community workspace 120, the secure workspace data repository 124 may store data associated with social and networking groups, events, and activities supported by a particular customer for its employees. In the expense reimbursement workspace 120, the secure workspace data repository 124 may store data associated with tracking, categorizing, and reimbursing expenses incurred by employees within the performance of their employment by a particular customer. In the learning workspace 120, the secure workspace data repository 124 may store data associated with continuing education of a customer's employees. In the employee survey workspace 120, the secure workspace data repository 124 may store data associated with surveys a particular customer conducts of its employees on a variety of topics. These are examples of various types of workspace data that may be stored on the secure workspace data repositories 124. Depending on the particular services offered by the human resources service and technology provider, other types of data may be stored as well.

Due to the sensitivity of the human resources data stored on the secure workspace data repositories 124, the data preferably is both stored and communicated in encrypted form. In particular, the data stored on the secure workspace data repositories 124 preferably may be stored in encrypted files or databases. In addition, all communications among the service workspace servers 122 and between the service workspace servers 122 and the human resources service and technology provider, its customers, and their employees, preferably may be encrypted to ensure data security. For example, such communications may be secured using end-to-end encryption.

The architecture 100 also includes a computer resource utilization monitoring system 110 that communicates over one or more networks with the servers 122 and secure workspace data repositories 124 of the various service workspaces 120. The computer resource utilization monitoring system 110 monitors the use of the service workspaces 120 by one or more customers and their employees to improve resource utilization. As described in more detail below, the computer resource utilization monitoring system 110 preferably receives data from the secure workspace data repositories 124 associated with the service workspaces. For each customer, the computer resource utilization monitoring system 110 calculates a customer engagement metric for each service workspace 120 based on that customers' use of the service workspace 120 and its associated computer resources. Based on these customer engagement metrics, the computer resource utilization monitoring system 110 may calculate a composite customer engagement score for the customer across multiple or all service workspaces 120. The human resources services and technology provider may use the customer engagement score to enhance customer engagement and to improve the computer resource utilization of the various service workspaces 120 and their supporting technology platforms for a particular customer or across a range of customers. Optionally, the customer engagement score may also be calculated based in part on the results of survey data collected from customers and their employees regarding use of the various service workspaces 120 and the computer resources that support them.

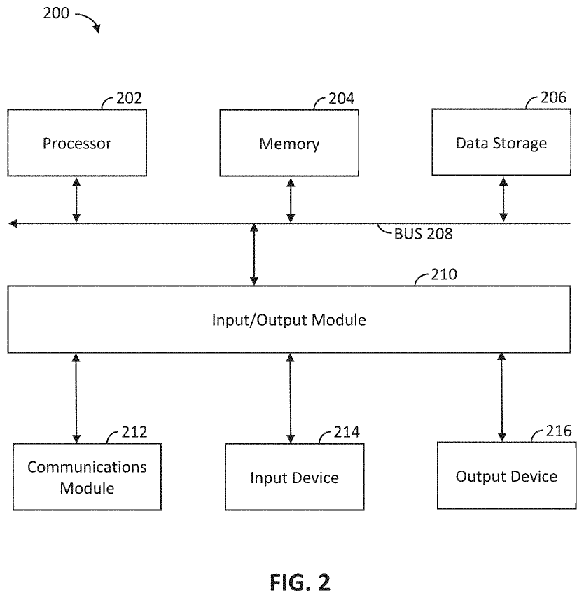

FIG. 2 is a block diagram illustrating a computer system 200 that may be used to implement the computer resource utilization monitoring system 110 and/or the service workspace servers 122 in the architecture 100 of FIG. 1 according to certain aspects of the disclosure. In certain aspects, the computer system 200 may be implemented using hardware or a combination of software and hardware, either in a dedicated server, or integrated into another entity, or distributed across multiple entities.

Computer system 200 includes a bus 208 or other communication mechanism for communicating information, and a processor 202 (e.g., processor 212 and 236) coupled with bus 208 for processing information. According to one aspect, the computer system 200 can be a cloud computing server of an IaaS that is able to support PaaS and SaaS services. According to one aspect, the computer system 200 is implemented as one or more special-purpose computing devices. The special-purpose computing device may be hard-wired to perform the disclosed techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques. By way of example, the computer system 200 may be implemented with one or more processors 202. Processor 202 may be a general-purpose microprocessor, a microcontroller, a Digital Signal Processor (DSP), an ASIC, a FPGA, a Programmable Logic Device (PLD), a controller, a state machine, gated logic, discrete hardware components, or any other suitable entity that can perform calculations or other manipulations of information.

Computer system 200 can include, in addition to hardware, code that creates an execution environment for the computer program in question, e.g., code that constitutes processor firmware, a protocol stack, a database management system, an operating system, or a combination of one or more of them stored in an included memory (e.g., memory 204), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 208 for storing information and instructions to be executed by processor 202. The processor 202 and the memory 204 can be supplemented by, or incorporated in, special purpose logic circuitry. Expansion memory may also be provided and connected to computer system 200 through input/output module 210, which may include, for example, a SIMM (Single In Line Memory Module) card interface. Such expansion memory may provide extra storage space for computer system 200, or may also store applications or other information for computer system 200. Specifically, expansion memory may include instructions to carry out or supplement the processes described herein, and may also include secure information. Thus, for example, expansion memory may be provided as a security module for computer system 200, and may be programmed with instructions that permit secure use of computer system 200. In addition, secure applications may be provided via the SIMM cards, along with additional information, such as placing identifying information on the SIMM card in a non-hackable manner.

The instructions may be stored in the memory 204 and implemented in one or more computer program products, e.g., one or more modules of computer program instructions encoded on a computer readable medium for execution by, or to control the operation of, the computer system 200, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, with languages, embeddable languages, and xml-based languages. Memory 204 may also be used for storing temporary variable or other intermediate information during execution of instructions to be executed by processor 202.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network, such as in a cloud-computing environment. The processes and logic flows described in this specification can be performed by one or more programmable processors executing one or more computer programs to perform functions by operating on input data and generating output.

Computer system 200 further includes a data storage device 206 such as a magnetic disk or optical disk, coupled to bus 208 for storing information and instructions. Computer system 200 may be coupled via input/output module 210 to various devices. The input/output module 210 can be any input/output module. Example input/output modules 210 include data ports such as USB ports. In addition, input/output module 210 may be provided in communication with processor 202, so as to enable near area communication of computer system 200 with other devices. The input/output module 210 may provide, for example, for wired communication in some implementations, or for wireless communication in other implementations, and multiple interfaces may also be used. The input/output module 210 is configured to connect to a communications module 212. Example communications modules 212 include networking interface cards, such as Ethernet cards and modems.

The components of the system can be interconnected by any form or medium of digital data communication, e.g., a communication network. In certain aspects, communications module 212 can provide a two-way data communication coupling to a network link that is connected to a local network. Wireless links and wireless communication may also be implemented.

Communications module 212 sends and receives electrical, electromagnetic or optical signals that carry digital data streams representing various types of information. The network link typically provides data communication through one or more local or wide area networks to other data devices. The networks both use electrical, electromagnetic or optical signals that carry digital data streams. The signals through the various networks and the signals on the network link and through communications module 212, which carry the digital data to and from computer system 200, are example forms of transmission media.

In certain aspects, the input/output module 210 is configured to connect to a plurality of devices, such as an input device 214 and/or an output device 216 (e.g., printer or display). Example input devices 214 include a keyboard and a pointing device, e.g., a mouse or a trackball, by which a user can provide input to the computer system 200. Other kinds of input devices 214 can be used to provide for interaction with a user as well, such as a tactile input device, visual input device, audio input device, or brain-computer interface device.

According to one aspect of the present disclosure, the service workspace servers 122 and the computer resource utilization monitoring system 110 can be implemented using a computer system 200 in response to processor 202 executing one or more sequences of one or more instructions contained in memory 204. Such instructions may be read into memory 204 from another machine-readable medium, such as data storage device 206. Execution of the sequences of instructions contained in main memory 204 causes processor 202 to perform the process steps described herein. One or more processors in a multi-processing arrangement may also be employed to execute the sequences of instructions contained in memory 204. Processor 202 may process the executable instructions and/or data structures by remotely accessing the computer program product, for example by downloading the executable instructions and/or data structures from a remote server through communications module 212 (e.g., as in a cloud-computing environment). In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. For example, some aspects of the subject matter described in this specification may be performed on a cloud-computing environment. Accordingly, in certain aspects a user of systems and methods as disclosed herein may perform at least some of the steps by accessing a cloud server through a network connection. Further, data files, circuit diagrams, performance specifications and the like resulting from the disclosure may be stored in a database server in the cloud-computing environment, or may be downloaded to a private storage device from the cloud-computing environment.

Computing system 200 can include clients and servers. A client and server are generally remote from each other and typically interact through a communication network. The relationship of client and server arises by virtue of computer programs running on the respective computers and having a client-server relationship to each other. Computer system 200 can be, for example, and without limitation, a desktop computer, laptop computer, tablet computer, mobile telephone, or other computing device.

The term “machine-readable storage medium” or “computer-readable medium” as used herein refers to any medium or media that participates in providing instructions or data to processor 202 for execution. The term “storage medium” as used herein refers to any non-transitory media that store data and/or instructions that cause a machine to operate in a specific fashion. Such a medium may take many forms, including, but not limited to, non-volatile media, volatile media, and transmission media. Non-volatile media include, for example, optical disks, magnetic disks, or flash memory, such as data storage device 206. Volatile media include dynamic memory, such as memory 204. Transmission media include coaxial cables, copper wire, and fiber optics, including the wires that comprise bus 208. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As used in this specification of this application, the terms “computer-readable storage medium” and “computer-readable media” are entirely restricted to tangible, physical objects that store information in a form that is readable by a computer. These terms exclude any wireless signals, wired download signals, and any other ephemeral signals. Storage media is distinct from but may be used in conjunction with transmission media. Transmission media participates in transferring information between storage media. For example, transmission media includes coaxial cables, copper wire and fiber optics, including the wires that comprise bus 208. Transmission media can also take the form of acoustic or light waves, such as those generated during radio-wave and infra-red data communications. Furthermore, as used in this specification of this application, the terms “computer”, “server”, “processor”, and “memory” all refer to electronic or other technological devices. These terms exclude people or groups of people. For the purposes of the specification, the terms display or displaying means displaying on an electronic device.

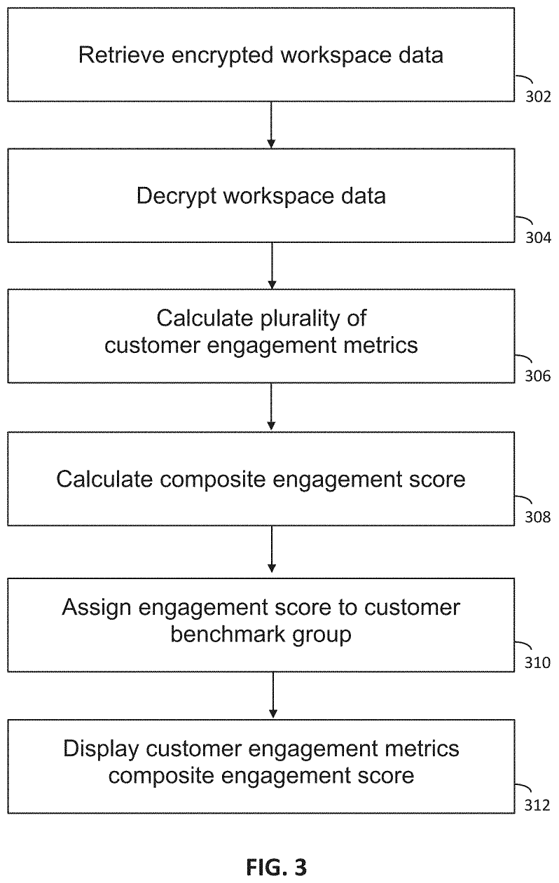

FIG. 3 illustrates an example process for improving computer resource utilization for a human resources service and technology provider maintaining a plurality of service workspaces 120. This process involves determining and using a composite customer engagement score based on a particular customer's utilization of computer resources across multiple service workspaces provided by the human resources service and technology provider.

In step 302, encrypted workspace data is retrieved from the secure workspace data repositories 124 of the service workspaces 120. For example, the encrypted workspace data may be retrieved by the service workspace servers 122. In step 304, the encrypted workspace data is decrypted to provide decrypted workspace data. The decryption may be performed by the service workspace servers 122, by the computer resource utilization monitoring system 110, or by another computer system suitable for decryption.

In step 306, a customer engagement metric is calculated for each service workspace 120 based on usage of the computer resources in that service workspace 120 by the customer and its employees. A variety of suitable customer engagement metrics may be used depending on the nature of a particular service workspace 120. The customer engagement metrics may be based on the percentage of employees who have actively used the service workspace 120 within a particular time period, such as daily, weekly, or monthly. For example, in the compensation service workspace 120, the metric may be based on the percentage of employees to whom the customer has assigned a compensation plan within the workspace 120. For the onboarding service workspace 120, the metric may be based on the percentage of new employees hired using the computer-based procedures available in the onboarding workspace 120. For the time and labor service workspace, the metric may be based on the percentage of employees using the scheduling workspace 120 or the percentage of employee hours tracked in the workspace 120. For the performance service workspace 120, the metric may be based on the number of employees for whom the performance workspace 120 has been used to track reviews and report employee performance. For the benefits workspace 120, the metric may be based on the percentage of eligible employees enrolled in benefits programs using the benefits workspace 120. For the payroll workspace 120, the metric may be based on the percentage of employees who have accessed paychecks or other payroll data electronically using the payroll workspace 120. For the community workspace 120, the metric may be based on the percentage of employees who have posted, commented, or reacted to announcements using the community workspace 120. For the expense workspace 120, the metric may be based on the percentage of employees who have submitted expense reports using the expense workspace 120. For the learning workspace 120, the metric may be based on the percentage of employees who have completed an online continuing education course using the learning workspace 120. For the surveys workspace, the metric may be based on the percentage of employees participating or creating electronic surveys using the surveys workspace 120. These examples of customer engagement metrics are provided by way of example only, and a variety of other customer engagement metrics may be used to track customer utilization of computer resources in a given service workspace 120.

In step 308, a composite customer engagement score is calculated based on the customer engagement metrics for each service workspace 120. Preferably, the composite customer engagement score is calculated based on a model that maximizes computer resource utilization across the various service workspaces 120. For example, the composite customer engagement score preferably may be a weighted average of the customer engagement metrics for the various service workspaces 120. Other methods of calculating the composite customer engagement score based on the customer engagement metrics may be used depending on the nature of the customer engagement metrics and other considerations such as the prioritization of particular computer resources or service workspaces 120.

In step 310, the customer and its composite customer engagement score are assigned to a customer benchmark group for comparative analysis. For example, assignment to a customer benchmark group may be based on the size of the customer company to enable comparison of customers having similar company size. Alternatively, assignment to a customer benchmark group may be based on the number of service workspaces 120 used by the customer or the customer's utilization of computer resources in one or more of those service workspaces 120. The assignment to a customer benchmark group also may be based on the industry in which the customer operates. For example, the assignment may be based on the customer's coding according to the North American Industry Classification System.

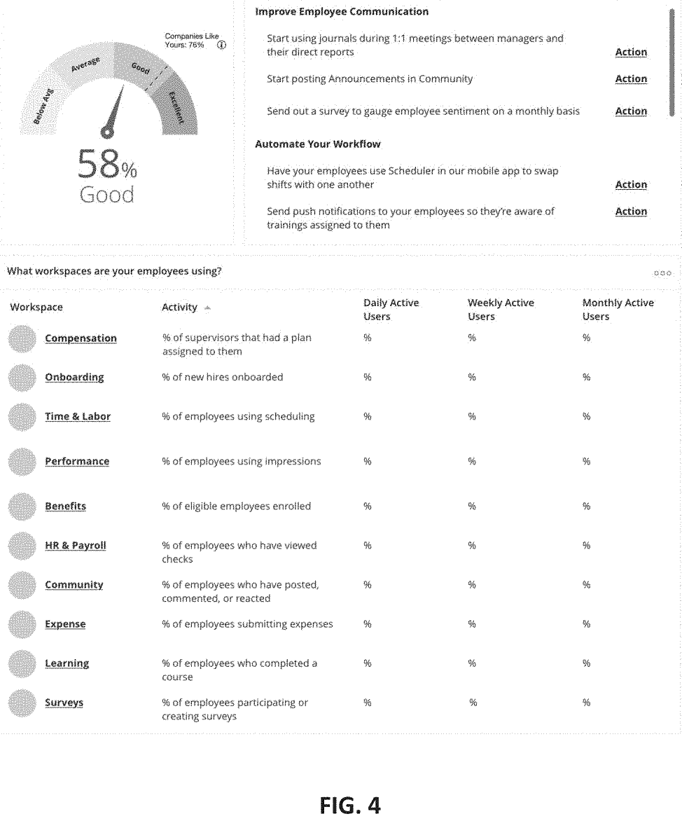

In step 312, the customer engagement metrics and/or the composite customer engagement score is displayed to an output device, such as a printer or a computer display. For example, the customer engagement metrics and the composite customer engagement score may be displayed to the human resources service and technology provider for consideration in allocating compute resources across the various service workspaces 120, as well as for to help in planning for future investment in technology to expand computer resources and service workspace 120 capacity. The customer engagement metrics and the composite customer engagement score also may be displayed to the customer to help the customer maximize its employees' utilization of the computer resources available across the various service workspaces 120. By way of example, the customer engagement metrics and the composite customer engagement score may be displayed as shown in FIG. 4.

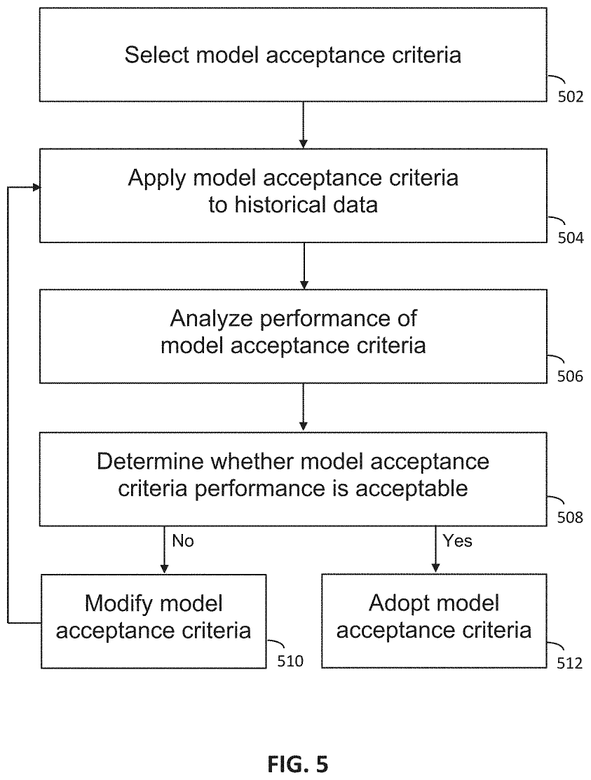

FIG. 5 illustrates another example process for improving computer resource utilization for a human resources service and technology provider maintaining a plurality of service workspaces 120. As discussed above, the human resources service and technology provider preferably may use a model to calculate the composite customer engagement score in a manner that maximizes computer resource utilization across the various service workspaces 120. To determine an appropriate model, the human resources service and technology provider may utilize model acceptance criteria to judge the effectiveness of the model. In step 502, model acceptance criteria are selected for consideration. In step 504, the selected model acceptance criteria are applied to historical data from the various service workspaces 120. For example, the model acceptance criteria may be used to calculate historical composite customer engagement scores for a number of customers across various service workspaces 120. In step 506, the performance of the model acceptance criteria is analyzed. For example, the historical composite customer engagement scores determined in step 504 may be compared to actual computer resource utilization and customer performance during those time periods. Step 508 determines whether the model acceptance criteria performance is acceptable. If not, the model acceptance criteria is modified in step 510, and the process returns to step 504 to apply and analyze the modified model acceptance criteria. Alternative, if the model acceptance criteria is determined to be acceptable in step 508, then the model acceptance criteria is accepted in step 512.

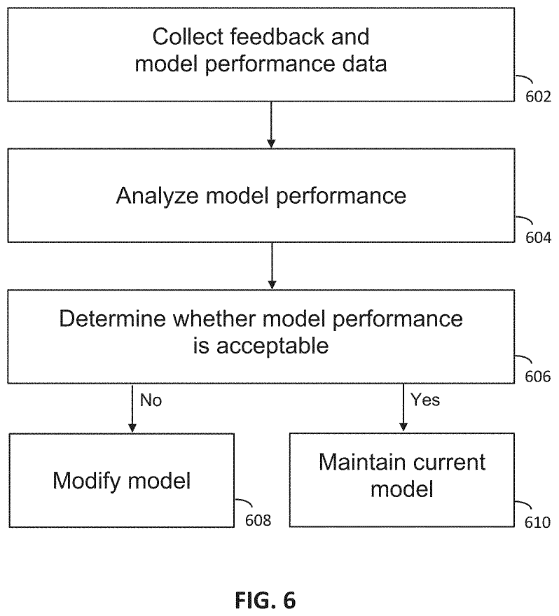

FIG. 6 illustrates another example process for improving computer resource utilization for a human resources service and technology provider maintaining a plurality of service workspaces 120. Even after selecting an appropriate customer engagement scoring model based on model acceptance criteria, the human resources service and technology provider may periodically wish to review the performance of the model based on actual model performance data and/or feedback from customers. Such model performance data and customer feedback are collected in step 602. Then, in step 604, the historical model performance is analyzed and a determination of whether the model performance is acceptable is made in step 606. If the human resources service and technology provider determines that the historical model performance is not acceptable, then the model is modified in step 608. Alternatively, if the historical model performance is acceptable, then the human resources service and technology provider maintains the current composite customer engagement scoring model in step 610.

To illustrate the interchangeability of hardware and software, items such as the various illustrative blocks, modules, components, methods, operations, instructions, and algorithms have been described generally in terms of their functionality. Whether such functionality is implemented as hardware, software or a combination of hardware and software depends upon the particular application and design constraints imposed on the overall system. Skilled artisans may implement the described functionality in varying ways for each particular application.

To the extent that the term “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for”.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A computer-implemented method for improving computer resource utilization comprising: retrieving a plurality of encrypted workspace data from a plurality of secure workspace data repositories associated with a plurality of human resources service workspaces; decrypting the plurality of encrypted workspace data to produce a plurality of decrypted workspace data; calculating a plurality of customer engagement metrics based on the plurality of decrypted workspace data, wherein each of the customer engagement metrics is associated with at least one of the plurality of human resources service workspaces; and calculating a composite customer engagement score based on the plurality of customer engagement metrics.

2. The computer-implemented method of claim 1, wherein at least one of the plurality of human resources service workspaces is associated with payroll services.

3. The computer-implemented method of claim 1, wherein at least one of the plurality of customer engagement metrics is measured by a number of active users of at least one of the plurality of human resources service workspaces.

4. The computer-implemented method of claim 1, further comprising: assigning the customer engagement score to a customer benchmark group.

5. The computer-implemented method of claim 4, wherein the customer benchmark group is defined based on a size of a customer company.

6. The computer-implemented method of claim 4, wherein the benchmark group is defined based on at least part of a numerical code assigned in accordance with the North American Industry Classification System.

7. The computer-implemented method of claim 1, wherein the customer engagement score is calculated according to a customer engagement score model.

8. The computer-implemented method of claim 7, further comprising: analyzing the performance of the customer engagement score model, and updating the customer engagement score model.

9. The computer-implemented method of claim 7, determining the customer engagement score model based on a plurality of model acceptance criteria.

10. The computer-implemented method of claim 9, further comprising: analyzing the performance of the plurality of model acceptance criteria, and updating the model acceptance criteria.

11. The computer-implemented method of claim 1, further comprising: analyzing a plurality of customer communications; determining a customer sentiment score based on the analysis of the plurality of customer communications; and calculating the customer engagement score based on the customer sentiment score.

12. The computer-implemented method of claim 1, further comprising: providing the customer engagement score to a customer

13. A system for improving computer resource utilization comprising: a networked storage device configured to store a plurality of secure workspace data repositories associated with a plurality of human resources service workspaces, wherein the plurality of secure workspace data repositories contain a plurality of encrypted workspace data; and at least one processor configured to execute computer code, which, when executed, cause the processor to retrieve the plurality of encrypted workspace data from each of a plurality of secure workspace data repositories, to decrypt the plurality of encrypted workspace data to produce a plurality of decrypted workspace data, to calculate a plurality of customer engagement metrics based on the plurality of decrypted workspace data, wherein each of the customer engagement metrics is associated with at least one of the plurality of human resources service workspaces, and to calculate a composite customer engagement score based on the plurality of customer engagement metrics.

14. The system of claim 13, wherein at least one of the plurality of human resources service workspaces is associated with payroll services.

15. The system of claim 13, wherein at least one of the plurality of customer engagement metrics is measured by a number of monthly active users of at least one of the plurality of human resources service workspaces.

16. The system of claim 13, further comprising: assigning the customer engagement score to a customer benchmark group.

17. The system of claim 16, wherein the customer benchmark group is defined based on a size of a customer company.

18. The system of claim 16, wherein the benchmark group is defined based on a percentage utilization of at least one of the plurality of human resources service workspaces.

19. The system of claim 16, wherein the benchmark group is defined based on at least part of a numerical code assigned in accordance with the North American Industry Classification System.

20. The system of claim 13, wherein the customer engagement score is calculated according to a customer engagement score model.

21. The computer-implemented method of claim 20, determining the customer engagement score model based on a plurality of model acceptance criteria.

22. The system of claim 13, further comprising: analyzing a plurality of customer communications; determining a customer sentiment score based on the analysis of the plurality of customer communications; and calculating the customer engagement score based on the customer sentiment score.

23. The system of claim 13, further comprising: providing the customer engagement score to a customer

24. A non-transitory machine-readable storage medium comprising machine-readable instructions which, when executed by at least one data processor forming part of at least one computing system, results in operations comprising: retrieving a plurality of encrypted workspace data from a plurality of secure workspace data repositories associated with a plurality of human resources service workspaces; decrypting the plurality of encrypted workspace data to produce a plurality of decrypted workspace data; calculating a plurality of customer engagement metrics based on the plurality of decrypted workspace data, wherein each of the customer engagement metrics is associated with at least one of the plurality of human resources service workspaces; and calculating a composite customer engagement score based on the plurality of customer engagement metrics.
